(19) United States
(12) Patent Application Publication
(10) Pub. No.: US 2004/0105938 A1
(43) Pub. Date: Jun. 3, 2004

(54) Accelerated petrifaction process for lignocellulose materials

(75) Inventor: Julio Burkhard Seeger Stein, Concepcion (CL)

Correspondence Address: Richard L. Byrne, 700 Koppers Building, 436 Seventh Avenue, Pittsburgh, PA, 15219-1818, US

(73) Assignees: Universidad de Conception; Burkkhard Seeger Stein; Aserraderos Quelen Quelen S.A.; Maderas Impregnadas Preserva Ltd.; Barraca y Fabrica de Muebles, Puertas y Ventanas Silvia Ugarte

(21) Appl. No.: 10/716,000

(22) Filed: Nov. 18, 2003

(30) Foreign Application Priority Data
Nov. 29, 2002 (CL) 2746-2002

(51) Int. Cl. B05D 1/18; B05D 3/00

(52) U.S. Cl. 427/440; 427/294; 427/351

(57) ABSTRACT

Disclosed is an accelerated petrifaction process of lignocellulose materials, including the step of impregnating with an aqueous solution an alkaline hydroxide and a soluble silicate, under pH conditions that permits its partial neutralization and insolubilization of the salts in situ in the interior of the lignocellulose material by the action of acid groups present in the lignocellulose material and the acidic action of carbon dioxide present in the surrounding air.

### FIELD OF THE INVENTION

The present invention refers to an accelerated process for petrifaction of wood and other lignocellulose material in one step that bestows a great resistance with respect to fungi, insects and other organisms as well as providing a characteristic of difficult inflammability and superior physicomechanical properties, without necessarily altering its natural appearance.

### BACKGROUND INFORMATION ON THE INVENTION

Wood has been used since immemorial times in the construction of houses, furniture, posts, bridges and other objects. However, its massive application has faced problems due to some of its negative characteristics: wood is highly flammable, is susceptible to attack by termites and other insects, and when in contact with moist soil it rots easily. This is especially true for low density, rapidly grown woods such as, for example, Pinus radiata D. Don.

Some wood treatment methods used to protect the wood against fungi and insects and that slow wood rotting are based in the use of creosote, the application of pentachlorophenol or tribromophenol or the impregnation with heavy metal salts such as CCA, based in copper, chrome and arsenic, among other methods. These processes have been widely used, but are problematic due to their use of fungicide compounds with toxic properties: they require careful use and produce sub-products during the impregnation process for treated wood that, after fulfilling a useful life, are considered dangerous residues. It is important to note that these substances do not protect the wood from fire.

There are numerous investigations and inventions seeking to find and propose alternative processes that, on the one hand, make wood durable with respect to pathogens under a variety of environmental conditions and on the other, are based in impregnating agents that do not negatively affect human health or hurt the environment. Additionally, they strive to make wood more fire resistant due to that its flammable nature has limited its use in construction.

Among the alternative impregnating agents, inorganic compounds play a fundamental role, and especially salts that contain silica, boron, copper, magnesium, titanium, ammonium, aluminum among others. To deposit these salts in the interstices of the wood requires a prior impregnation of the wood in a first stage with a solution containing the active agent to permit wood penetration by the salts. Subsequently, the salts must precipitate and/or form an insoluble compound that avoids a lixiviation of the agent, if the wood receives water or is found in a highly humid environment. For this reason, the majority of the proposed processes are long, require several stages and diverse reactives, and definitely have not been implemented at an industrial level.

The present invention is based in the insolubilization of silicon salts, alternatively together with boron salts, in the interior of the wood, in adequate proportions and dilutions and under determined operating conditions, achieving as a result a petrified lignocellulose material with highly superior characteristics when compared with the original ones.

The next part discusses the actual state of the art with respect to the use of silica salts, the impregnating agent of the present invention. The principal challenge and, at the same time, the principal difference with the different, previously known processes lies in the diverse technological alternatives used to fix the silica in the wood interior.

Lilla (U.S. Pat. No. 3,974,318) proposes a wood impregnation process in two stages: First, a vacuum/pressure impregnation with a solution of sodium silicate, then a drying process for the wood. In a second stage, a second impregnation with a solution containing metal salts that form silicates insoluble in water and, in this way, permits the precipitation of silicon in the wood interior.

A process proposed by Simak et al. (U.S. Pat. Nos. 6,040,057 and 6,146,766) is based in a wood impregnation process with soluble silicates and its insolubilization by thermic treatment. Similarly, St.-Michel (U.S. Pat. No. 4,642,268) proposes an external protector film for roofing products based in wood and asphalt, which is obtained applying a film of a solution of silicon salts and then their drying. Crews IV et al. (U.S. Pat. No. 5,205,874) proposes a superficial protection for metals and wood through the application of one or more films of silicates soluble in water and their conversion to silicon dioxide with a phosphoric acid treatment.

Additionally, two Japanese patents are based in wood impregnation with silicon salts and a natural polysaccharide: Inque and Tsujimura (U.S. Pat. No. 5,549,739) uses chitin and colloidal silica at a neutral pH value with the option to add other substance like boron, copper, titanium among others; Moriya and Motai (JP 10-017.426) describe an impregnation that is based in the utilization of sodium silicate, two additional inorganic compounds and an extract of red algae.

Finally, Kaellstroem EP 0.221.868 describes a process to produce fire-resistant walls that is based in the incorporation of silicates, cement and water.

Together with the silicon salts, it is worthwhile in many cases to add boron salts to the impregnating solution in order to accentuate the fire resistant and pathogenic qualities of the petrified wood. Boric acid, as well as borax and other tetraborates, are present in the market at low prices. Boron is not considered a toxic element for human health and is even a necessary element for plant growth. However, its use presents two difficulties: it requires the incorporation of boron into the wood, either as an acid or as a water-soluble salt, in sufficiently high concentrations, in order to achieve the desired preservation effect. However, the low solubility of boric acid, borax and the tetraborates in water makes it difficult to achieve the desired concentration in the wood. Furthermore, the boron must be fixed in the interior of the lignocellulose material to avoid its lixiviation with water during its use, which is very difficult to achieve, due to the partial solubility of the boron salts.

Based on this information, there are several patents that are based in diverse principles and technology for wood impregnation with agents that contain boron:

Short and Rayfleld (U.S. Pat. No. 4,706,871) proposes the introduction of boron in the wood interior in the form of boric acid esters, which would then be hydrolyzed. In this way, they argue, it is possible to obtain boron concentration between 0.5 and 3.5% in the treated wood. Nasheri (U.S. Pat. No. 5,871,817) plants a similar process, using methanol or ethanol together with boric acid. Patel et al. (U.S. Pat. No. 4,719,110) proposes an impregnation with a solution produced by the mixture of sodium tetraborate and phosphoric acid in a 5:3 molar relation at the boiling temperature of the mixture in a aqueous medium. A patent of Murphy et al. (U.S. Pat. No. 5,330,847) is based in the use of metallic esters of boron, which forms an azeotrope with an alcohol and can be hydrolyzed in the wood interior.

Other authors recommend the use of solutions containing organic solvents as means of transport for the active agents based in boron: Bechgaard (U.S. Pat. No. 4,610,881) proposes the use of ethylenglycol, Palmere et al. (U.S. Pat. No. 5,104,664) proposes a mixture of glycols and Dunstan and Bartlett (U.S. Pat. No. 5,601,849) propose polyethylenglycol, Paysant (U.S. Pat. No. 5,846,305) proposes the simultaneous impregnation of compounds based in copper and boron dissolved in a solution that contains an amine as well as a glycol.

At the same time, there are diverse patents that plant different alternatives for retaining boron in the wood interior:

Thompson (U.S. Pat. No. 5,151,127) plants the encapsulation of diverse active agents; among them are borax, boric acid or boric oxide, in an acrylic resin. Hsu et al. (U.S. Pat. No. 5,246,652) proposes the production of wood based panels by a process that includes wood impregnation with boric acid or a water-soluble borate and the use of phenolic resins as adhesive. Slimak and Slimak (U.S. Pat. No. 6,146,766) propose an impregnation with sodium silicate and, optionally, a mixture of boric acid and sodium borate to make the compounds insoluble by radiant energy, electric current, microwave, convection ovens, zone heating, etc. at an elevated temperature for short periods of time. Schubert et al. (U.S. Pat. No. 5,612,094) make boric acid insoluble with a solution of water-soluble zirconium salt.

### DESCRIPTION OF THE INVENTION

In many locations of the world, wood that has been preserved for a long time can frequently be found due to a natural process called petrifaction. This process consists, basically, in the contact of the wood with waters that contain small concentrations of soluble silice, which under adequate conditions penetrates the wood and is deposited in its interior. In nature, this process is very slow and takes thousands of years. The positive result is evident with respect to the durability of petrified wood vis-a-vis microorganisms and the fire.

The present invention is based on an accelerated wood petrifaction process, similar to the natural process, but which can, however, be performed in a very short period of time. The process can be applied to any type of wood and even other lignocellulose materials, although it has been demonstrated to be especially useful for pine and other low density woods, which are used for structural, constructive, industrial, decorative, agricultural, and among others ends such as: construction panels, windows, doors, floors, posts, beams, poles, furniture, terraces, bridges, machine parts, and others. It is appropriate for interior as well as exterior use, and even in contact with soil and water.

Consequently, an alternative process is proposed for wood preservation with respect to microorganism action as well as to fire that does not present operational, environmental or toxicological problems, characteristic of the other existing industrial alternatives actually used that are based in the fungicide characteristics of active toxic compounds.

The process consists in an impregnation, in one stage, of the wood with a water-soluble, petrifying agent consisting of silicon salts or, alternatively, silicon salts and boron salts. The precipitation of the petrifying agent occurs in situ, in the interior of the lignocellulose material, and does not require the addition of insolubilizing compounds.

The impregnation can be performed in the same way that the conventional processes are performed, and even using the same vacuum—pressure equipment. The wood can be dry or have a high humidity, but to increase the rapidity of penetration by the petrifying agent, a water content equal or lower than 30% is preferred. In the same way, the application of vacuum, as a stage prior to impregnation, and/or the application of pressure during the impregnation, preferably between 8 and 16 atmospheres for 10 min to 300 min, permits an uniform penetration of the wood, although these conditions are not indispensable elements of the process. In fact, it is possible to apply the impregnating agent superficially to the wood, via the immersion of the wood in a bath that contains the petrifying agent or through its application with showers, brushes, rollers or other means, particularly if the prevention of fungus growth, such as blue-staining fungi (Ceroatocystis pilifera), in its surface is also desired.

The precipitation of the petrifying agent from the aqueous solution in the wood interior occurs due to a diminution in the pH value of the liquid after impregnation as a result of the action of the acidic groups of the wood produced by the process's operating conditions and the neutralizing action of carbon dioxide present in the atmosphere. The alternative exists, as well, to apply a washing solution containing only water or water with small quantities of salts or acids that accelerate the diminution in the pH and favors the velocity of insolubilization. The washing solution can contain an organic or inorganic acid; especially useful are mineral acids such as sulfuric acid, hydrochloric acid, nitric acid or boric acid. A mixture of acids or of acids and salts can equally be used. During the washing, a solubilization of silice or boron is not produced if the methodological procedure of the present invention is followed.

The content of silice in the wood can vary in a wide range, depending on the intended final use, by varying the silice concentration in the impregnating solution and the operating conditions of the impregnation process. The concentration range depending on the use can vary between approximately 4 and 126 kg/m³ of wood.

Together with the silice it could be convenient, depending on the characteristics that one wants to impart to the petrified lignocellulose material, to incorporate boron salts that can translate into greater stability with respect to fire and insect and fungus action, if the process is performed according to the conditions of the present invention, which are based in the high solubility of sodium or potassium metaborate in an aqueous solution at an alkaline pH value, ideally between 11 and 12. In this way, the incorporation of a high concentration of boron in the wood interior is possible without having to fall back on the troublesome and expensive procedures such as the esterification of boric acid or the use of organic solvents during impregnation. Additionally, under the mentioned conditions, it is possible to impregnate the wood together with the silicon salts, a central aspect of the present invention, because the insolubilization of the silicates, due to a change in the pH value, permits the retention of boron salts in the wood interior in a silica matrix and crystallized due to their lower solubility, as tetraborate or boric acid.

The boron can be incorporated as sodium or potassium metaborates or prepared previously by means of the reaction of boric acid, borax or other alkaline tetraborates with a highly disassociated hydroxide. The concentration of the soluble metaborate salt is 0.05 at 0.7% of boron in weight, preferably between 0.1 and 0.3% of boron in weight. The effective quantity of preserver to apply to the wood will depend on the desired preservation type, where the boron concentration varies between 0.2 and 3.20 kg/m³ of wood, preferably between 0.4 and 1.4 kg/m ³.

The wood treated according to the ambit of the present invention is difficult to inflame, difficult to putrefy, and is not attacked by termites. Additionally, the wood maintains its natural color or is changed in only an imperceptible way by the impregnation process, differing from the action of other commonly used impregnators. The wood color is much less affected by the exposition to light and humidity, when it is compared with untreated wood. The treated wood increases its hardness and improves its mechanical and dimensional stability properties.

### SUMMARY

A fast [symbol] (Accelerated)? petrification process for lignocellulose materials, and especially for low density wood for construction, housing, industrial, decorative, agricultural as well as other uses like: the fabrication of paneling, windows, doors, floors, posts, beams, poles, furniture, terraces, bridges, machine parts and many others for interior and exterior use, and even in contact with soil and water, is produced through an impregnation with an alkaline hydroxide solution and a water soluble silicate, altermatively including soluble salts of a metaborate, and its insolublization in situ due to the action of acidic organic groups liberated by the components of the lignocellulose material due to the conditions characteristic of the process and the presence of carbon dioxide in the surrounding air.

The petrified lignocellulose material inflames and putrefies with great difficulty and is not attacked by termites or other insects; its aspect changes slightly over time, increasing its hardness and improving its characteristics of mechanical resistance and dimensional stability. The properties can be adjusted according to the intended final use by varying the concentration of the constituents and the operating process conditions.

### LITERATURE

Insertar la bibliografia

### EXPERIMENTAL EXAMPLES

### Example 1

Ten wood samples of radiata pine of 50×20×15 mm with a water content of 12% were treated in an array of impregnators at a laboratory scale. The operating conditions used in the impregnation were the following:

| Item | Operating Conditions |
|---|---|
| No. of samples | 10 |
| Liquor concentration (K/A) (%) | 7/0.05 |
| Initial Vacuum (min) | 10 |
| Impregnation at 14 (KG/cm2) (min) | 30 |
| Intermediate Vacuum (min) | 10 |
| Water washing (min) | 15 |
| Final Vacuum (min) | 10 |

The termites were placed in glass recipients that contained the test sample in humid sand, sterilized and rich in silicates. Subsequently, the recipients were placed in a culture chamber at temperatures of 24.5±1° C. and a relative humidity of 75±5%. The tests were performed according to the European Norm EN 117/ACI of 1990 to determine the efficacy threshold with respect to Reticulitermes sp (subterranean termites) under laboratory conditions. The duration of the test was 8 weeks and was performed in triplicate.

At the end of the test, the test samples were removed from the recipients and a visual inspection was performed to characterize the termite attack according to its location, extension and depth. A census of termites was also performed to determine the survival and/or mortality rate of the population.

The following table was used as a base for the visual evaluation of the test pieces.

| Attack level | Wood Characteristics |
|---|---|
| 0 | No attack |
| 1 | Tentative attack: Cleanliness or surface rubbing |
| | of a immeasurable depth or an attack exactly at |
| | a depth of 0.5 mm if this is restricted to three |
| | areas of less than 3 mm of diameter each one. |
| 2 | Light attack: surface attack (<1 mm) and limited |
| | in extension to at most 1/10 of the surface of the |
| | test piece or one orifice of depth less than 3 mm. |
| 3 | Medium attack: surface attack (<1 mm) of more |
| | than 1/10 of the surface of the test piece or with |
| | clear-cut holes that do not extend into caverns |
| | and with a depth greater than 3 mm. |
| 4 | Strong attack: Surface erosion that involves |
| | more than 1/10 of the surface of the test piece or |
| | penetrating attack that is greater than 3 mm and |
| | extends into caverns in the test mass and could |
| | lead to a very advance state of destruction. |

Results

| Test Pieces | Attack Level |
|---|---|
| Untreated wood | |
| Sample 1 | Strong Attack (Level 4) |
| Sample 2 | Strong Attack (Level 4) |
| Sample 3 | Strong Attack (Level 4) |
| Treated wood | |
| Sample 1 | No attack (Level 0) |
| Sample 2 | Tentative Attack (Level 1) |
| Sample 3 | Tentative Attack (Level 1) |

According to the Table, the treated wood presented a high resistance to termite attack, differing from the untreated the wood that manifested a strong attack.

### Exmaple 2

Wood samples of radiata pine of 50×20×15 mm with a water content of 12% were treated in an array of impregnators at a laboratory scale. The operating conditions used in the impregnation were the following:

| Item | Operating Conditions |
|---|---|
| No. of samples | 10 |
| Liquor concentration (K/A) (%) | 5/0.2 |
| Initial Vacuum (min) | 10 |
| Impregnation at 14 (KG/cm2) (min) | 30 |
| Intermediate Vacuum (min) | 10 |
| Water washing (min) | 15 |
| Final Vacuum (min) | 10 |

The treated wood, like the untreated wood samples, experienced termite action following the same procedure described in Example 1.

Results

| Test Pieces | Attack Level |
|---|---|
| Untreated wood | |
| Sample 1 | Strong Attack (Level 4) |
| Sample 2 | Strong Attack (Level 4) |
| Sample 3 | Strong Attack (Level 4) |
| Treated wood | |
| Sample 1 | No attack (Level 0) |
| Sample 2 | No attack (Level 0) |
| Sample 3 | Tentative Attack (Level 1) |

It was verified that the treated wood is resistant to termite attack, which was not the case of the untreated wood that presented a strong attack.

### Example 3

Wood samples of radiata pine of 50×25×15 mm with a water content of 12% were treated in a array of impregnators at a laboratory scale. The operating conditions used in the impregnation were the following:

| Item | Operating Conditions |
|---|---|
| No. of samples | 10 |
| Liquor concentration (K/A) (%) | 3/0.2 |
| Initial Vacuum (min) | 10 |
| Impregnation at 14 (KG/cm2) (min) | 30 |
| Intermediate Vacuum (min) | 10 |
| Water washing (min) | 15 |
| Final Vacuum (min) | 10 |

The treated wood, like the untreated wood samples, experienced termite action following the same procedure described in Example 1.

Results

| Test Pieces | Attack Level |
|---|---|
| Untreated wood | |
| Sample 1 | Strong Attack (Level 4) |
| Sample 2 | Strong Attack (Level 4) |
| Sample 3 | Strong Attack (Level 4) |
| Treated wood | |
| Sample 1 | No attack (Level 0) |
| Sample 2 | Tentative Attack (Level 1) |
| Sample 3 | Tentative Attack (Level 1) |

Once again, it was established that the treated wood is resistant to termite action, while the untreated wood was strongly attacked.

### Example 4

Three wood samples of radiata pine of 15 cm×15 mm×10 mm thickness with a water content of 12% were treated in an array of impregnators at a laboratory scale. The operating conditions used in the impregnation were the following:

| Liquors | | Wood | |
|---|---|---|---|
| K (%) | A (%) | K (%) | A (%) |
| 9.0 | 0.22 | 7.0 | 0.3 |

The tests pieces were evaluated with respect to their fire resistance following the Norm ISO 5660-1 “Fire test—reaction to fire—rate of heat release from building products”, known as the calorimetric cone methodology.

Results

Average of the Results
for the three samples

| | Untreated | Treated |
|---|---|---|
| Measured Parameters | Wood | Wood |
| Thickness (mm) | 12.3 | 11.0 |
| Ignition Time (s) | 13.0 | 18.3 |
| Rate of heat release (KW/m²) | 88.1 | 40.76 |
| Effective Combustion Heat (MJ/kg) | 13.8 | 16.43 |
| Reason of weight loss (m²/kg) | 0.05 | 0.02 |
| Smoke release (m2/kg) | 88.8 | 48.59 |
| Prod. of Carbon Monoxide (kgCO/kg) | 0.027 | 0.05 |
| Prod. of Carbon Dioxide (kgCO₂/kg) | 1.83 | 2.68 |

According to the table, the treated wood is superior in all the evaluated characteristics with respect to untreated wood.

### Example 5

Three wood samples of radiata pine of 15 cm×15 cm×10 mm thickness with a water content of 12% were treated in an array of impregnators of laboratory scale. The operating conditions used in the impregnation were the following:

| Liquors | | Wood | |
|---|---|---|---|
| K (%) | A (%) | K (%) | A (%) |
| 12.0 | 0.1 | 9.0 | 0.1 |

The treated and untreated samples were submitted to fire resistance tests similar to those signaled in Example 4.

Results

Average of the Results
for the three samples

| | Untreated | Treated |
|---|---|---|
| Measured Parameters | Wood | Wood |
| Thickness (mm) | 12.3 | 13.5 |
| Ignition Time (s) | 13.0 | 22.0 |
| Rate of heat release (KW/m²) | 88.1 | 50.46 |
| Effective Combustion Heat (MJ/kg) | 13.8 | 10.2 |
| Reason of weight loss (m²/kg) | 0.05 | 0.043 |
| Smoke release (m2/kg) | 88.8 | 50.3 |
| Prod. of Carbon Monoxide (kgCO/kg) | 0.027 | 0.031 |
| Prod. of Carbon Dioxide (kgCO₂/kg) | 1.83 | 1.56 |

It was observed that the treatment is effective in improving the wood's fire resistance.

### Example 6

Three wood samples of radiata pine of 15 cm×15 cm×10 mm thickness, dried to a water content of 12% were treated in a array of impregnators of laboratory scale. The operating conditions used in the impregnation were the following:

| Liquors | | Wood | |
|---|---|---|---|
| K (%) | A (%) | K (%) | A (%) |
| 11.0 | 0.6 | 10.0 | 0.6 |

Fire resistance tests similar to those described in Example 4 were performed on the treated and untreated samples.

Results

| | Average of the | |
|---|---|---|
| | Results for the three samples | |
| Measured Parameters | Untreated Wood | Treated Wood |
| Thickness (mm) | 12.3 | 13.5 |
| Ignition Time (s) | 13.0 | 22.0 |
| Rate of heat release (KW/m²) | 88.1 | 50.46 |
| Effective Combustion Heat (MJ/kg) | 13.8 | 10.2 |
| Smoke release (m2/kg) | 0.05 | 0.043 |
| Reason of weight loss (m²/kg) | 88.8 | 50.3 |
| Prod. of Carbon Monoxide | 0.027 | 0.031 |
| (kgCO/kg) | | |
| Prod. of Carbon Dioxide (kgCO₂/kg) | 1.83 | 1.56 |

Under the described conditions, the petrifaction process was found to be very effective in providing the wood with fire resistance qualities.

### Example 7

Three wood samples of radiata pine of 15 cm×15 cm×10 mm thickness, dried to a water content of 12% were treated in an array of impregnators at a laboratory scale. The operating conditions used in the impregnation were the following:

| Liquors | | Wood | |
|---|---|---|---|
| K (%) | A (%) | K (%) | A (%) |
| 5.0 | 0.2 | 5.9 | 0.25 |

Fire resistance tests similar to those described in Example 4 were performed on the treated and untreated samples.

Results

| | Average of the | |
|---|---|---|
| | Results for the three samples | |
| Measured Parameters | Untreated Wood | Treated Wood |
| Thickness (mm) | 12.3 | 11.5 |
| Ignition Time (s) | 13.0 | 22.0 |
| Rate of heat release (KW/m²) | 88.1 | 60.8 |
| Effective Combustion Heat (MJ/kg) | 13.8 | 10.3 |
| Reason of weight loss (m²/kg) | 0.05 | 0.051 |
| Smoke release (m2/kg) | 88.8 | 54.0 |
| Prod. of Carbon Monoxide | 0.027 | 0.024 |
| (kgCO/kg) | | |
| Prod. of Carbon Dioxide (kgCO₂/kg) | 1.83 | 1.54 |

The treated wood exhibited better fire resistance properties than the untreated wood.

### Example 8

Three wood samples of radiata pine of 15 cm×15 cm×10 mm thickness, dried to a water content of 12% were treated in an array of impregnators at a laboratory scale.

The operating conditions used in the impregnation were the following:

| Liquors | | Wood | |
|---|---|---|---|
| K (%) | A (%) | K (%) | A (%) |
| 3.0 | 0.2 | 3.2 | 0.22 |

Results

Fire resistance tests similar to those described in Example 4 were performed on the treated and untreated samples.

Results

| | Average of the | |
|---|---|---|
| | Results for the three samples | |
| Measured Parameters | Untreated Wood | Treated Wood |
| Thickness (mm) | 12.3 | 11.0 |
| Ignition Time (s) | 13.0 | 22.0 |
| Rate of heat release (KW/m²) | 88.1 | 83 |
| Effective Combustion Heat (MJ/kg) | 13.8 | 14 |
| Reason of weight loss (m²/kg) | 0.05 | 0.05 |
| Smoke release | 88.8 | 41.0 |
| Prod. of Carbon Monoxide | 0.027 | 0.025 |
| (kgCO/kg) | | |
| Prod. of Carbon Dioxide (kgCO₂/kg) | 1.83 | 1.5 |

Once again, an improvement in fire resistance was observed in the wood treated by the petrifaction process with respect to the untreated wood.

1. Accelerated petrifaction process of lignocellulose materials to increase its characteristics of resistance to fire, termites and fungi as well as to improve its physical-mechanical properties, CHARACTERIZED by being realized in only one process step, which consists in the impregnation with an aqueous solution of an alkaline hydroxide and a soluble silicate, under pH conditions that permits its subsequent partial neutralization and the consequent insolublization of the salts “in situ” in the interior of the lignocellulose material by the action of acid groups present in the lignocellulose material and the acidic action of carbon dioxide present in the surrounding air.

2. Accelerated petrifaction process of lignocellulose materials to increase its characteristics of resistance to fire, termites and fungi as well as to improve its physical-mechanical properties, according to claim 1, CHARACTERIZED because the impregnation with silica occurs in a range of pH between 9 and 13, and preferably between 11 and 12.

3. Accelerated petrifaction process of lignocellulose materials to increase its characteristics of resistance to fire, termites and fungi as well as to improve its physical-mechanical properties, according to claims 1 and 2, CHARACTERIZED because the impregnation is performed with wood whose humidity content fluctuates between 1 and 50%, and preferably less than 30%.

4. Accelerated petrifaction process of lignocellulose materials to increase its characteristics of resistance to fire, termites and fungi as well as to improve its physical-mechanical properties, according to claims 1 to 3, CHARACTERIZED because the soluble silicate used is sodium silicate, in a silice solution with a concentration between 1 and 28% in weight, preferably between 4 and 16% in weight.

5. Accelerated petrifaction process of lignocellulose materials to increase its characteristics of resistance to fire, termites and fungi as well as to improve its physical-mechanical properties, according to claims 1 to 4, CHARACTERIZED because the soluble silicate used is potassium silicate, in a silicon solution with a silicon dioxide concentration between 1 and 28% in weight, preferably between 4 and 16% in weight.

6. Accelerated petrifaction process of lignocellulose materials to increase its characteristics of resistance to fire, termites and fungi as well as to improve its physical-mechanical properties, according to claims 1 to 5, CHARACTERIZED because the impregnation is performed under vacuum and pressure conditions in one or more successive cycles of vacuum and pressure.

7. Accelerated petrifaction process of lignocellulose materials to increase its characteristics of resistance to fire, termites and fungi as well as to improve its physical-mechanical properties, according to claims 1 to 6, CHARACTERIZED because the impregnation is performed under a pressure of 1 to 20 atmospheres, preferably 8 to 15 atmospheres during a period of 10 to 300 minutes, preferably from 15 to 60 minutes.

8. Accelerated petrifaction process of lignocellulose materials to increase its characteristics of resistance to fire, termites and fungi as well as to improve its physical-mechanical properties, according to claims 1 to 5, CHARACTERIZED because the impregnation stage is performed by immersion at atmospheric pressure.

9. Accelerated petrifaction process of lignocellulose materials to increase its characteristics of resistance to fire, termites and fungi as well as to improve its physical-mechanical properties, according to claims 1 to 5, CHARACTERIZED because the impregnation stage is performed with showers or other aspersion methods.

10. Accelerated petrifaction process of lignocellulose materials to increase its characteristics of resistance to fire, termites, and fungi as well as to improve its physical-mechanical properties, according to claims 1 to 9, CHARACTERIZED because to the solution of an alkaline hydroxide and a silicate, used for impregnation, soluble metaborate salts are added.

11. Accelerated petrifaction process of lignocellulose materials to increase its characteristics of resistance to fire, termites, and fungi as well as to improve its physical-mechanical properties, according to claims 1 to 10, CHARACTERIZED because the metaborate is produced previously through the reaction of boric acid with a highly dissociated hydroxide and is later added to the silicate solution.

12. Accelerated petrifaction process of lignocellulose materials to increase its characteristics of resistance to fire, termites, and fungi as well as to improve its physical-mechanical properties, according to claims 1 to 10, CHARACTERIZED because the metaborate is produced through the reaction of soluble sodium or potassium tetraborate with a highly dissociated hydroxide and it is later added to the silicate solution.

13. Accelerated petrifaction process of lignocellulose materials to increase its characteristics of resistance to fire, termites, and fungi as well as to improve its physical-mechanical properties, according to claims 1 to 12, CHARACTERIZED because the concentration of the impregnating solution has a content of soluble metaborate of 0.02 to 0.7% of boron in weight, preferably between 0.1 and 0.3% of boron in weight.

14. Accelerated petrifaction process of lignocellulose materials to increase its characteristics of resistance to fire, termites, and fungi as well as to improve its physical-mechanical properties, according to claims 1 to 13, CHARACTERIZED because the final concentration of boron in the lignocellulose material is 0.08 and 3.20 kg/m³, preferably 0.40 to 1.40 kg/m³ of wood and of 4 to 126 kg/m³ of silice, preferably between 18 and 74 kg/m³ of wood.

15. Accelerated petrifaction process of lignocellulose materials to increase its characteristics of resistance to fire, termites, and fungi as well as to improve its physical-mechanical properties, according to claims 1 to 14, CHARACTERIZED because the insolubilization of silice and boron can be facilitated in the interior of the lignocellulose material due to a subsequent washing stage with water, with water acidulated with inorganic acids, organic acids, and/or salts or a mixture of them.

16. Accelerated petrifaction process of lignocellulose materials to increase its characteristics of resistance to fire, termites, and fungi as well as to improve its physical-mechanical properties, according to claims 1 to 15, CHARACTERIZED because the washing is performed with a solution that contains small quantities of sulfuric acid, hydrochloric acid, nitric acid, boric acid, phosphoric acid, acetic acid, formic acid or a mixture of them.

17. Accelerated petrifaction process of lignocellulose materials to increase its characteristics of resistance to fire, termites, and fungi as well as to improve its physical-mechanical properties, according to claims 1 to 16, CHARACTERIZED because the washing is performed with a soluble alkalinearth element solution (calcium, strontium or barium, as soluble chlorides or nitrates).

18. Accelerated petrifaction process of lignocellulose materials to increase its characteristics of resistance to fire, termites, and fungi as well as to improve its physical-mechanical properties, according to claims 1 to 17, CHARACTERIZED because the washing with water or with a liquid of more acidic characteristics than those of the impregnating liquid occurs under vacuum and pressure conditions.

19. Accelerated petrifaction process of lignocellulose materials to increase its characteristics of resistance to fire, termites, and fungi as well as to improve its physical-mechanical properties, according to claims 1 to 17, CHARACTERIZED because the washing with water or with a liquid of more acidic characteristics than those of the impregnating liquid occurs via baths, or other methods of immersion, or showers or other methods of aspersion.
